(19) United States
(12) Patent Application Publication
(10) Pub. No.: US 2023/0292704 A1
(43) Pub. Date: Sep. 21, 2023

(54) Vehicle Cupholder Insert Pet Cup

(71) Applicant: Marvis Munroe, Stoneville, SD (US)

(72) Inventor: Marvis Munroe, Stoneville, SD (US)

(21) Appl. No.: 18/183,589

(22) Filed: Mar. 14, 2023

Related U.S. Application Data
(60) Provisional application No. 63/319,808, filed on Mar. 15, 2022.

(51) Int. Cl. A01K 5/01; A01K 7/00

(52) U.S. Cl. CPC A01K 5/0135; A01K 7/005

(57) ABSTRACT

The present invention relates to a pet cup that includes a bowl portion and a lower insert portion. The bowl portion is adapted to store water or food for a pet. The bowl portion functions as a container to hold the water or food, while the lower insert portion snugly fits into a cupholder of a vehicle. The cup is convenient to travel with, and adapted for use in a moving vehicle without any slippage, spillage or injury to the pet consuming water or food from the cup. When the cup is placed in a cupholder, the bowl portion can rest on the cupholder and partially on the surface around the cupholder, for enabling the pet to access the water or food while the cup is secured to the cupholder.

### CROSS-REFERENCE TO RELATED APPLICATION

The present application claims priority to, and the benefit of, U.S. Provisional Application No. 63/319,808, which was filed on March 15th, 2022 and is incorporated herein by reference in its entirety.

### FIELD OF THE INVENTION

The present invention relates generally to the field of pet bowls. More specifically, the present invention relates to a pet cup or bowl to be used as a cupholder insert for securely feeding pets in a moving vehicle. The pet cup/bowl is designed for a pet, in particular, a dog to eat and drink therefrom while traveling in a car or truck. The cup features a bowl portion and a lower insert portion wherein the bowl portion stores water or pet food, and the lower insert portion snugly fits into a cupholder of a vehicle. The lower insert portion prevents the slippage of the cup even during sudden acceleration and deceleration of the vehicle. During high speeds of the vehicle, the cup/bowl remains stable, and a pet can securely eat or drink from the cup/bowl. The cup/bowl can be placed in a rear or front cup holder, and obviates the need to stop on the side of the road to enable pets to eat or drink. Accordingly, the present disclosure makes specific reference thereto. Nonetheless, it is to be appreciated that aspects of the present invention are also equally applicable to other like applications, devices, and methods of manufacture.

### BACKGROUND

In general, when individuals go for a trip such as in a vehicle, individuals take their pets with them. Many individuals are not comfortable leaving their pets alone at home or with strangers. However, when pet owners take their pets with them, they are often worried that their pets, and in particular dogs, will not have convenient access to food and water while enroute. Conventionally, a bowl, containing water or food, is placed on the floor of a vehicle for the pet to drink. In moving vehicles, this leads to the water being spilled onto the carpet of the car due to either movement of the pet or movement of the vehicle. While the car is moving, sudden acceleration or deceleration can cause injury to the pet while the pet is consuming its food. The mouth or snout of the dog can be injured by the bowl placed on any surface of the vehicle. Also, pet owners can themselves spill water or food when pouring contents into unstably placed feeding bowls for their pets while in vehicles. Individuals are not only worried about the cleanliness of the vehicle and other passengers, but also about the safety of the pet.

In some situations, when pet owners need to leave the car for few minutes, they are in constant fear for their pets as the pets can spill the water or food they may be consuming in the vehicle. Individuals may end up being in the vehicle until the pet finishes the water or they may take the pet with them, which may not always be possible.

Individuals generally stop their vehicles to enable their pet to drink water or consume food. This is not always possible and is also not a safe option for individuals and pets. It is not always safe to stop vehicles at night and/or around other moving vehicles.

Therefore, there exists a long felt need in the art for a dog cup/bowl that provides a stable and secure place for placing pet food and water in a vehicle. There is also a long felt need in the art for an improved pet feeding vessel that enables pets to have water and food in a moving vehicle. Additionally, there is a long felt need in the art for an improved pet feeding vessel that eliminates the chances of slippage of a feeding bowl in a vehicle. Moreover, there is a long felt need in the art for a dog cup/bowl that obviates the need to stop a vehicle on the side of the road to enable pets to eat or drink. Furthermore, there is a long felt need in the art for a feeding bowl that enables the pet owner to securely and conveniently pour water and dispense food in a moving vehicle. Finally, there is a long felt need in the art for a dog cup/bowl that enables pets to easily eat or drink from the cup/bowl when traveling in a vehicle without any injury, spillage or slippage.

The subject matter disclosed and claimed herein, in one embodiment thereof, comprises a cupholder insert dog cup/bowl. The dog cup/bowl snugly fits into a vehicle’s cupholder for preventing spillage while the vehicle is moving. The dog cup/bowl features a bowl portion and a tubular, cylindrical or frustoconical lower insert portion, wherein the lower insert portion is integrally or detachably attached to the base of the bowl portion. The bowl portion includes an arcuate-shaped cup wall extending outwardly from the base to the top lip and defines a continuous opening for storing edible material therein. The exterior surface of the cup wall can include a small finger handle for handling the cup by a user for inserting or removing the cup from the cupholder. The lower insert portion is configured to snugly fit into a cupholder of a vehicle, such that the base of the bowl portion rests on or above the cupholder wherein the bowl portion is accessible by the dog for consuming the contents placed therein.

In this manner, the cupholder insert dog cup/bowl of the present invention accomplishes all of the forgoing objectives, and provides access to a food and water container for pets to be used while traveling in a vehicle. The dog cup/bowl snugly fits into the cupholder and thus prevents spills and injury to the pets. The dog cup/bowl enables pet owners to leave the pet unattended for a short period of time with peace of mind, and obviates the need to stop on the side of the road to enable pets to eat or drink. A pet can securely drink water and consume food from the dog cup/bowl irrespective of sudden acceleration and deceleration of the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cupholder insert dog cup/bowl. The dog cup/bowl is configured to snugly fit into a vehicle’s cupholder for preventing spillage during vehicle movement. The dog cup/bowl further comprising a bowl portion and a lower insert portion, wherein the lower insert portion is integrally-attached to the base of the bowl portion. The bowl portion includes an arcuate-shaped cup wall extending outwardly from the base to a top lip and defines a continuous opening therearound for storing edibles for a dog. The exterior surface of the cup wall includes a small finger handle for grasping the cup by a user. The lower insert portion, for example, is tubular or cylindrical, and is configured to snugly fit into a cupholder of a vehicle such that the base of the bowl portion rests on the upper surface of the cupholder wherein the bowl portion is accessible by the dog for consuming the contents placed therein.

In yet another embodiment, the bowl portion is covered by a lid that secures the contents stored in the bowl portion.

In accordance with another feature of the present invention, the bowl portion is viewable from outside and includes a logo on its exterior surface. The lower insert portion is hidden inside the cupholder when the dog cup/bowl is secured in the cupholder of the vehicle.

In yet another embodiment of the present invention, a pet feeding vessel designed to be used as a cupholder insert is disclosed. The pet feeding vessel is used for providing food, water and/or medicine to a pet, such as a dog, in a vehicle and especially in a moving vehicle. The vessel includes an upper main container configured to function as a bowl portion and includes a broader top lip and a narrower base. The vessel also includes a lower insert portion configured to snugly fit inside a cupholder. The bowl portion rests on the cupholder and partially on the surface surrounding the cupholder, when the lower insert portion is positioned inside the cupholder enabling the pet to securely consume the food or medicine in a moving vehicle.

In yet another embodiment of the present invention, the lower insert portion is integrally or detachably-attached to the upper main container.

In yet another embodiment, the lower insert portion can have a tubular, frustoconical, cylindrical, or any other geometrical shape to fit inside a front or rear cupholder of a vehicle or a truck.

In yet another embodiment, the vessel includes a plurality of markings or gradations for indicating to a pet owner the quantity of water or food stored in the bowl portion.

In yet another embodiment, the vessel or the cup/bowl remains snugly inserted inside the cupholder when a sudden acceleration or deceleration of the vehicle takes place, and therefore prevents slippage of the cup and also prevents injury to the pet while consuming food, water, or medicine from the cup in a moving vehicle.

An advantage of the present dog cup/bowl cupholder insert is that the cup enables pets to easily eat or drink from the cup when traveling in the back or front seat of a car or truck and obviates the need to stop the vehicle on the side of a road to enable pets to eat or drink.

An advantage of the present dog cup/bowl cupholder insert is that the present device comes in various sizes and shapes to fit into cupholders of currently available vehicles and trucks. Further, the cup can be used for food, water, water dishes and medicines.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle cupholder dog cup/bowl insert of the present invention in accordance with the disclosed architecture;

FIG. 2 illustrates a partial perspective view of an interior of a vehicle having one potential embodiment of the vehicle cupholder dog cup/bowl insert of the present invention disposed in a cup holder in accordance with the disclosed architecture;

FIG. 3 illustrates a partial perspective view of an interior of a vehicle having one potential embodiment of the vehicle cupholder dog cup/bowl insert of the present invention disposed in a cup holder being used by a dog for consuming food or drink in accordance with the disclosed architecture; and

FIG. 4 illustrates a perspective view of another potential embodiment of a cupholder cup/bowl insert of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a dog cup/bowl that provides a stable and secure place for placing pet food and water in a vehicle. There is also a long felt need in the art for an improved pet feeding vessel that enables pets to have water and food in a moving vehicle. Additionally, there is a long felt need in the art for an improved pet feeding vessel that eliminates chances of slippage of a feeding bowl in a vehicle. Moreover, there is a long felt need in the art for a dog cup/bowl that obviates the need to stop a vehicle on the side of the road to enable pets to eat or drink. Furthermore, there is a long felt need in the art for a feeding bowl that enables the pet owner to conveniently pour water and dispense food in a moving vehicle. Finally, there is a long felt need in the art for a dog cup/bowl that enables pets to easily eat or drink from the cup/bowl when traveling in a vehicle without any injury, spillage or slippage.

The present invention, in one exemplary embodiment, is a novel pet feeding vessel designed to be used as a cupholder insert. The pet feeding vessel is used for providing food or water to a pet, such as a dog, in a moving vehicle. The vessel includes an upper main container configured to function as a bowl portion and includes a broader top lip and a narrower base. The vessel also includes a lower insert portion configured to snugly fit inside a cupholder. The bowl portion rests on the cupholder, and partially on the surface surrounding the cupholder, when the lower insert portion is positioned inside the cupholder, thereby enabling the pet to securely consume the food, water and/or medicine in a moving vehicle.

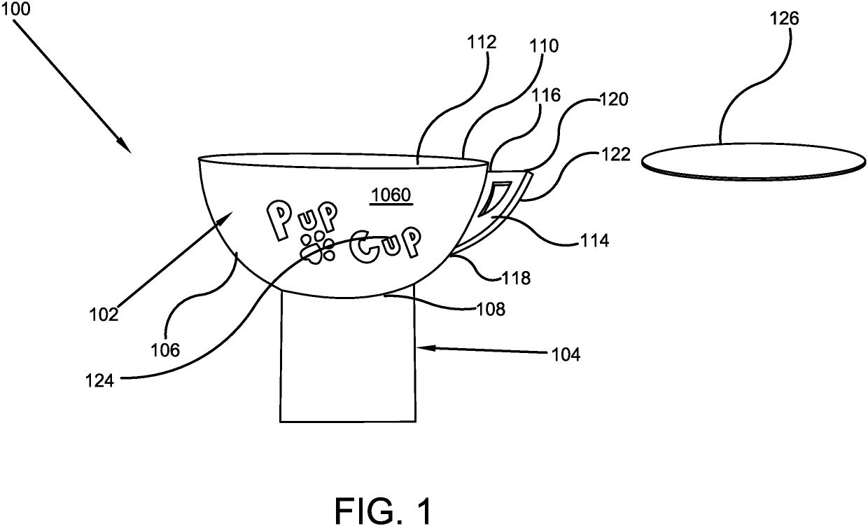

Referring initially to the drawings, FIG. 1 illustrates a perspective view of one potential embodiment of a vehicle cupholder dog cup/bowl insert 100 of the present invention in accordance with the disclosed architecture. The vehicle cupholder pet cup/bowl insert 100 of the present invention is designed as a vehicle cup/bowl for a dog to eat and drink therefrom, while traveling in a car or truck. The cup 100 carries food or drink, which permits an animal such as a dog to drink or eat freely from the cup/bowl 100 in a moving vehicle, wherein the cup/bowl 100 has been secured within a cupholder of the vehicle. The vehicle cup 100 is securely placed in the cupholder such that in an event where the vehicle reaches a sudden break in motion or a speed change, the cup 100 remains secured in the cupholder without any lateral motion, tilting, or breakage. More specifically, the dog cup/bowl 100 includes an upper main container or bowl portion 102, and a lower insert portion 104. The bowl portion 102 is configured to retain contents such as pet food or drinking water and is defined by a cup wall 106 that extends from a base 108 to a top lip or rim 110. The base 108 can be substantially flat or planar, and the cup wall 106 can extend in an upwardly arcuate shape from the base 108 to the top lip or rim 110. The top lip 110 is generally circular and defines a continuous opening 112. The opening 112, base 108, and wall 106 define a cavity for retaining food and water therein, and for providing access thereto. A small finger handle 114 adapted to accommodate at least one finger of a user is positioned on the exterior surface 1060 of the cup wall 106. The small finger handle 114 conforms to the arcuate shape of the cup wall 106 and includes an upper end 116 and a lower end 118. The upper end 116 includes a horizontal member 120 that extends horizontally from the exterior surface 1060, and an arcuate or arch member 122 which connects the horizontal member 120 and the lower end 118. The exterior surface 1060 of the cup wall 106 can include a logo or any other indicia 124 such as “Pup Cup” that can be used for advertising, marketing and trademark purposes.

The lower insert portion 104 of the cup 100 can be a cylindrical member that extends vertically downward from the main container 102. The lower insert portion 104 can be integrally attached to the base 108 of the container 102, and is designed to be secured inside a cup holder of a vehicle such that the when the lower insert portion 104 is inserted into the cupholder, the main body 102 can rest on an upper surface of the cupholder and is readily accessible by a dog for eating and drinking. The lower insert portion 104 snugly and securely fits inside a cupholder in a vehicle, thereby enabling the dog to use the cup/bowl 100 for eating and drinking from the main container 102 in a moving vehicle, without any fear of spillage and breakage of the cup 100. It should be appreciated that the lower insert portion 104 is configured to stabilize the bowl portion 102 and mitigate against the spillage of the contents during feeding or drinking of the dog. The lower insert portion 104 can be solid or hollow, and conforms to the shape and size of the cupholder in which the cup 100 is used. In one potential embodiment, the lower insert portion 104 can have a texture, ridges, or bumps (not shown) formed thereon, additional gripping material such as rubber or silicone (not shown) disposed therearound, and/or selectively removable wraps or layers for customizing the fit within the cupholder to mitigate against sliding or movement of the lower insert portion 104 within the cupholder.

The cup 100 can optionally come with a lid 126 for covering the opening 112 for securing the stored food or drink items in the main container 102. The lid 126 seals the opening 112 and is secured to the top lip 110 and is used when the cup 100 is not being used by a dog. The lid 126 can be magnetic and can be magnetically-secured to the top lip 110 of the bowl portion 102.

In potential embodiments, the diameter of the circular top lip or rim 110 is generally in the range from about 4 inches to about 10 inches. The depth of the main container 102 is generally in the range from about 2 inches to about 6 inches. The base 108 can be substantially flat and includes a diameter generally in the range from about 2 inches to about 5 inches. The lower insert portion 104 includes a length generally in the range from about 2 inches to about 5 inches. The diameter of the lower insert portion 104 is generally in the range from about 2 inches to about 4 inches. In another embodiment, the diameter of the lower insert portion 104 is from about 2.5 inches to about 3.5 inches. For accommodating a finger of a user while saving space in placing the cup 100 in a cupholder of a vehicle, the length or extension of the horizontal member 120 is generally in the range from about 1 inch to about 3 inches.

The base 108 of the container 102 can also be slightly curved in one embodiment, so that contents of the main container 102 gravitate toward the center as material is consumed by a dog and the arcuate shape of the cup wall 106 obviates any corners where material might collect.

An advantage of the dog cup/bowl 100 of the present invention is that the arcuate shape of the bowl portion 102 works naturally and interactively with dog’s natural behavior, as the dogs tend to lap the food or water and generally push forward while doing so.

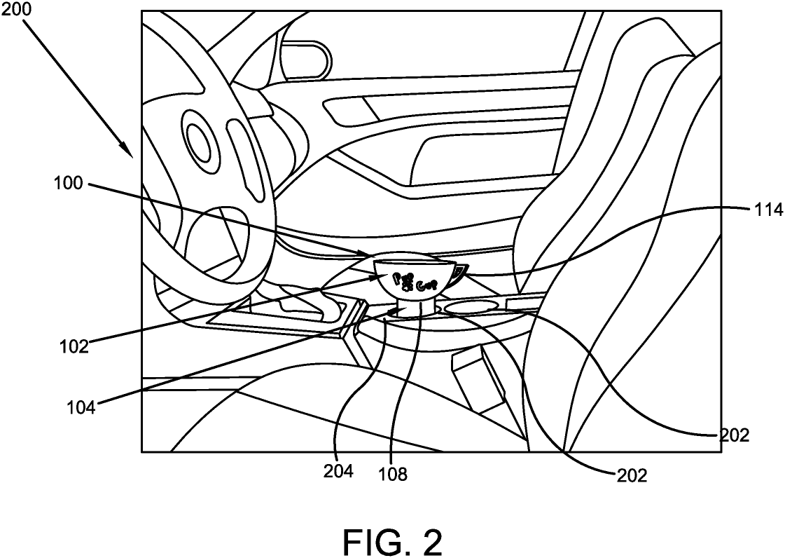

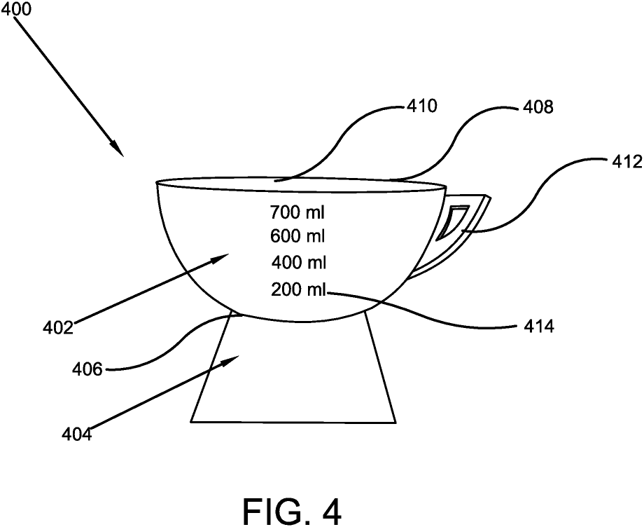

FIG. 2 illustrates a partial perspective view of an interior of a vehicle having the vehicle cupholder dog cup/bowl insert 100 of the present invention disposed in a cup holder in accordance with the disclosed architecture. As shown in FIG. 2, the dog cup/bowl 100 is especially adapted to be disposed and secured in a cupholder 202 of a vehicle 200. The lower insert portion 104 of the dog cup/bowl 100 is secured in the cupholder 202 such that the base 108 of the bowl portion 102 can rest on the cupholder 202 and on a surface 204 around cupholder 202, wherein the contents stored in the bowl portion 102 can be securely accessed by the pet. The lower insert portion 104 is configured to stabilize the bowl portion 102, and mitigate against the spillage of the contents during eating or drinking by the dog using the cup holder 202. When the vehicle 200 moves, the cup 100 does not move and enables pets to easily eat or drink from the cup 100 when traveling in the back or front seat of a car. The small finger handle 114 enables a user to easily remove the cup 100 from the cup holder 202 when not being used. The lower insert portion 104 can be tubular or cylindrical in the present embodiment, however, it should be appreciated that the lower insert portion 104 can be of any other suitable shape chosen by one skilled in the art, as desired (refer to FIG. 4).

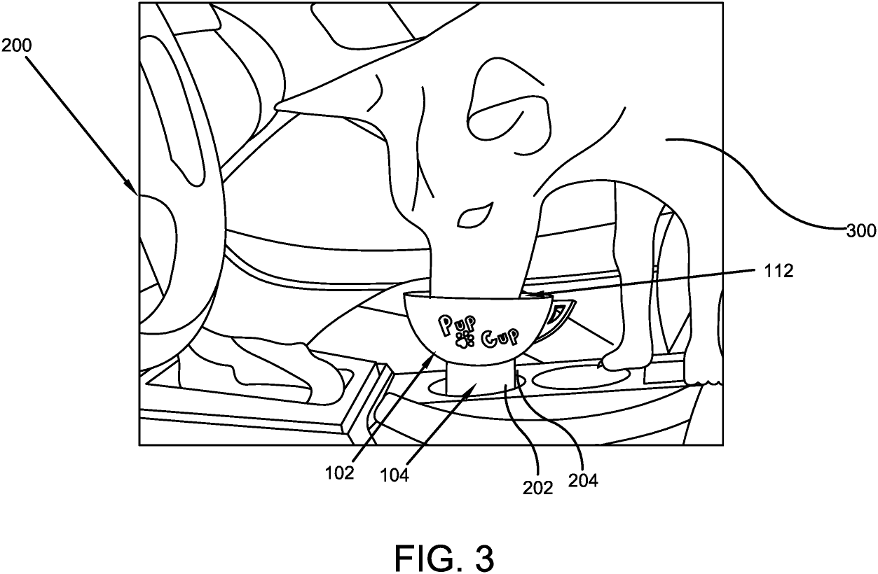

FIG. 3 illustrates a partial perspective view of an interior of a vehicle having the vehicle cupholder dog cup/bowl insert 100 of the present invention disposed in a cup holder and being used by a dog for consuming food or water in accordance with the disclosed architecture. As shown, the cup 100 can be placed in the cupholder of the vehicle 200. A pet 300, such as a dog, can securely and without any slippage of the dog cup/bowl 100, consume the food or water stored in the bowl portion 102 through the opening 112. The lower insert portion 104 secures the cup 100 in high speeds, during sudden jerks, and during momentum changes of the vehicle 200, thereby eliminating the need to stop the vehicle 200 on the side of a road to enable the pet 300 to eat or drink. Further, the bowl portion 102 does not hurt the pet’s 300 mouth or snout when the vehicle 200 is subjected to a sudden acceleration or deceleration.

The cup insert 100 of various embodiments of the present invention can be manufactured of a variety of materials including plastic, high-density polyethylene, soft wood, cardboard, combinations thereof or any other suitable material chosen by a skilled artisan. The material can be fluid-impermeable. The bowl portion 102 can also be formed from an insulating material or be vacuum-jacketed in order to minimize heat transfer between the interior and the exterior of the bowl portion 102. The insulating material may include a neoprene covering, for example. The cup 100 retains its shape, is hygienic, dishwasher safe and has no hard surfaces or edges which might possibly injure the pet 300 while consuming an item from the bowl portion 102. The cup insert 100 can come in various sizes and shapes to fit cupholders of various vehicles and trucks. Further, the bowl portion 102 can be configured for small dogs, medium dogs and large dogs.

FIG. 4 illustrates a perspective view of another embodiment of the pup cup of the present invention in accordance with the disclosed architecture. In many vehicles and trucks, cup holders are generally frustoconical in shape. Thus, in the present embodiment, and as shown in FIG. 4, the lower insert portion 404, disposed under the bowl portion 402, is integrally-attached to the base 406 and includes a corresponding frustoconical shape. It should be appreciated that the frustoconical shape snugly conforms and secures to common types of the frustoconical cup holders. Further, the bowl portion 402 can have markings or graduations 414 to indicate food or content level in the cup 100 to a user, and can be used for maintaining known quantities to the pet. The opening 410, defining the circular top lip or rim 408, is used for pouring contents in the bowl 402, and accessing same, and the handle 412 can be used for placing and removing the cup 400 from any frustoconical cupholder.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle cupholder dog cup/bowl insert”, “vehicle cup”, “pup cup”, “cup”, “pet feeding vessel”, “cup insert”, and “dog cup/bowl”, are interchangeable and refer to the vehicle cupholder dog cup/bowl insert 100, 400 of the present invention.

Notwithstanding the forgoing, the vehicle cupholder dog cup/bowl insert 100, 400 of the present invention can be of any suitable size and configuration as is known in the art without affecting the overall concept of the invention, provided that it accomplishes the above-stated objectives. One of ordinary skill in the art will appreciate that the size, configuration, and material of the vehicle cupholder dog cup/bowl insert 100, 400 as shown in the FIGS. are for illustrative purposes only, and that many other sizes and shapes of the vehicle cupholder dog cup/bowl insert 100, 400 are well within the scope of the present disclosure. Although the dimensions of the vehicle cupholder dog cup/bowl insert 100, 400 are important design parameters for user convenience, the vehicle cupholder dog cup/bowl insert 100, 400 may be of any size that ensures optimal performance during use, and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle cupholder pet cup insert comprising:
an upper container comprising a base, an arcuate side and a top rim defining a cavity for retaining a content therein during movement of a vehicle in which the vehicle cupholder pet cup insert is positioned; and
a lower insert portion having a length for inserting into a vehicle cupholder, wherein the length is from about 2 inches to about 5 inches.

2. The vehicle cupholder pet cup of claim 1, wherein said top rim is circular.

3. The vehicle cupholder pet cup of claim 1 further comprising a finger handle connected to said arcuate side and adapted to accommodate at least one finger of a user.

4. The vehicle cupholder pet cup of claim 1, wherein said upper container is a bowl.

5. The vehicle cupholder pet cup of claim 4, wherein said content is a water.

6. The vehicle cupholder pet cup of claim 4, wherein said content is a pet food.

7. The vehicle cupholder pet cup of claim 2, wherein said top rim includes a diameter of about 4 inches to about 10 inches.

8. The vehicle cupholder pet cup of claim 7, wherein said diameter is from about 5 inches to about 8 inches.

9. The vehicle cupholder pet cup of claim 7 further comprising a lid magnetically connected to said top rim of said upper container.

10. The vehicle cupholder pet cup of claim 7, wherein said upper container comprises a depth from about 2 inches to about 6 inches.

11. The vehicle cupholder pet cup of claim 10, wherein said depth is from about 3 inches to about 5 inches.

12. The vehicle cupholder pet cup of claim 11, wherein said lower insert portion is cylindrical in shape and comprises a diameter from about 2 inches to about 4 inches.

13. A vehicle cupholder pet bowl insert comprising:
an upper container comprising a base, an arcuate side and a top rim defining a cavity for retaining a content therein during movement of a vehicle, wherein said top rim is circular in shape and has a diameter from about 4 inches to about 10 inches; and
a lower insert portion comprising a length and a diameter sized and configured to be inserted into a vehicle cupholder, wherein said length is from about 2 inches to about 5 inches and said diameter of said lower insert portion is from about 2 inches to about 4 inches.

14. The vehicle cupholder pet bowl insert of claim 13 further comprising a finger handle connected to said arcuate side and adapted to accommodate at least one finger of a user.

15. The vehicle cupholder pet bowl insert of claim 14, wherein said top rim diameter is from about 5 inches to about 8 inches.

16. The vehicle cupholder pet bowl insert of claim 13 further comprising a lid magnetically connected to said top rim of said upper container.

17. The vehicle cupholder pet bowl insert of claim 13, wherein said upper container comprises a depth from about 2 inches to about 6 inches.

18. The vehicle cupholder pet bowl insert of claim 13, wherein said lower insert portion is frustoconical.

19. A vehicle cupholder dog bowl insert comprising:
an upper container comprising a base, an arcuate side and a top rim defining a cavity for retaining a content therein during a movement of a vehicle, wherein said top rim is circular in shape and comprises a diameter from about 4 inches to about 10 inches; and
a lower insert portion comprising a length from about 2 inches to about 5 inches and a diameter from about 2 inches to about 4 inches, wherein said lower insert portion is comprised of a material selected from a group consisting of a rubber and a silicone.

20. The vehicle cupholder dog cup of claim 19, wherein said upper container comprises a depth from about 2 inches to about 6 inches.
